(19) United States
(12) Patent Application Publication
(10) Pub. No.: US 2005/0108134 A1
(43) Pub. Date: May 19, 2005

(54) Managing an investment portfolio

(76) Inventors: William Van Harlow, Concord, MA (US); Ralph Joseph Wolf, Lunenburg, MA (US); Eric Francois Penanhoat, Scituate, MA (US)

Correspondence Address: FISH & RICHARDSON PC, 225 FRANKLIN ST, BOSTON, MA, 02110, US

(21) Appl. No.: 10/712,082

(22) Filed: Nov. 13, 2003

(51) Int. Cl. G06F 17/60

(52) U.S. Cl. 705/36; 705/38

(57) ABSTRACT

There are methods and apparatus, including computer program products, for managing an investment portfolio. For example, there is a method that includes receiving asset classes with corresponding sets of financial data, determining variation information for the sets of financial data, and determining a final set of factors based on the variation information.

### BACKGROUND

This invention relates to managing an investment portfolio.

One of the objectives of modern financial theory is to facilitate rational decision making in the presence of risk and uncertainty. Typically, the approaches to solve this problem require a decision maker (e.g., a portfolio manager, trader, or other investor) to evaluate risk associated with a portfolio containing assets from a variety of asset classes. Risk models are used to characterize risk of assets with respect to various, potentially correlated, risk factors.

### SUMMARY

In one aspect, there is a method. The method includes receiving asset classes with corresponding sets of financial data, determining variation information for the sets of financial data, and determining a final set of factors based on the variation information.

Other examples may include one or more of the following features.

The method includes determining risk associated with a portfolio of one or more assets using information derived from the final set of factors. The information derived from the final set of factors includes risk factor coefficients calculated using a regression based on the final set of factors and historical data for the one or more assets. Determining the final set of factors includes determining an initial set of factors based on the variation information, and determining the final set of factors based on a plurality of principal components associated with the initial set of factors. The final set of factors are associated with mutually independent random variables, and correspond to mutually uncorrelated series of numbers, respectively corresponding to series of samples of the mutually independent random variables.

A first one of the sets of financial data includes a plurality of index return series, each index return series including a plurality of historical prices of a financial index. The variation information for the first one of the sets of financial data includes a set of mutually uncorrelated return series. Determining the variation information for the first one of the sets of financial data includes calculating a first covariance matrix based on the plurality of index return series, calculating a first set of eigenvectors and corresponding first set of eigenvalues for the first covariance matrix, selecting a subset of the first set of eigenvectors, based on the corresponding first set of eigenvalues, and determining the set of mutually uncorrelated return series based on the subset of the set of eigenvectors. Determining the final set of factors includes calculating a second covariance matrix based on an aggregate set of return series which includes the set of mutually uncorrelated return series, calculating a second set of eigenvectors for the second covariance matrix, and determining the final set of factors based on the second set of eigenvectors.

In another aspect, there is a system. The system includes a factor module configured to receive asset classes with corresponding sets of financial data, determine variation information for each of the sets of financial data, and determine a final set of factors based on the variation information.

Other examples may include one or more of the following features.

The system includes an analyzer module configured to determine risk associated with a portfolio of one or more assets using information derived from the final set of factors. The system includes a rebalancer module configured to determine a rebalanced portfolio based on risk associated with a risk target, wherein the risk associated with the rebalanced portfolio is closer to the risk associated with the risk target than the risk associated with the portfolio is close to the risk associated with the risk target.

In another aspect, there is an article of manufacture having computer-readable program portions embodied therein. The article includes instructions for causing a processor to perform any combination of the methods described above.

One or more of the following advantages may be provided by one or more of the aspects described above.

A risk management program helps an investor (a user of the program) manage an investment portfolio of various assets. The investor can organize the investment portfolio using folders or “sub-portfolios” which help the investor focus on a particular aspect of his or her investment strategy. The program helps the investor narrow down the list of potential investments in a sub-portfolio from perhaps thousands of investment options from various asset classes (e.g., individual stocks, mutual funds, bonds, real estate, cash) to a more manageable list of potential investments. Given the investor's initial investment portfolio and a desired benchmark, the program enables the investor to determine a sensible adjustment to his or her investment portfolio and/or sub-portfolios.

The program uses a risk model to assess risk for various potential sub-portfolios, helping the investor evaluate different sub-portfolios based on their potential risks. In calculating risk, the program can include data for a broad range of asset classes. The program characterizes and quantifies the potential risk or volatility of a mixed sub-portfolio in isolation or in relation to a benchmark.

Providing a decision-maker (e.g., the investor, or a manager acting on behalf of the investor) with a graphical user interface of textual and graphical information for the sub-portfolios on any day selected by the decision-maker enables the decision-maker to analyze different aspects of risk. Further, considering historical or simulated returns for assets currently held in a portfolio more accurately analyzes the risks associated with the portfolio rather than considering the portfolio's returns history which reveals the risks associated with a manager of the portfolio.

Furthermore, a risk management program enables a decision-maker to drive the analysis of an investment portfolio by enabling the decision-maker to choose or define acceptable risks and investment choices. The risk management program uses these user inputs to analyze the investment portfolio and construct hypothetical rebalancings of the sub-portfolios allowing the decision-maker to repeatedly alter his or her choices.

Other advantages and features will become apparent from the following description and from the claims.

### DESCRIPTION OF DRAWINGS

FIG. 1 is a diagram of a network configuration.

FIG. 2A is an alternate view of the network configuration of FIG. 1.

FIG. 2B is a screenshot of an example graphical user interface.

FIG. 3 is a flowchart of a risk management process.

FIG. 4 is a chart illustrating an example risk factor model.

### DETAILED DESCRIPTION

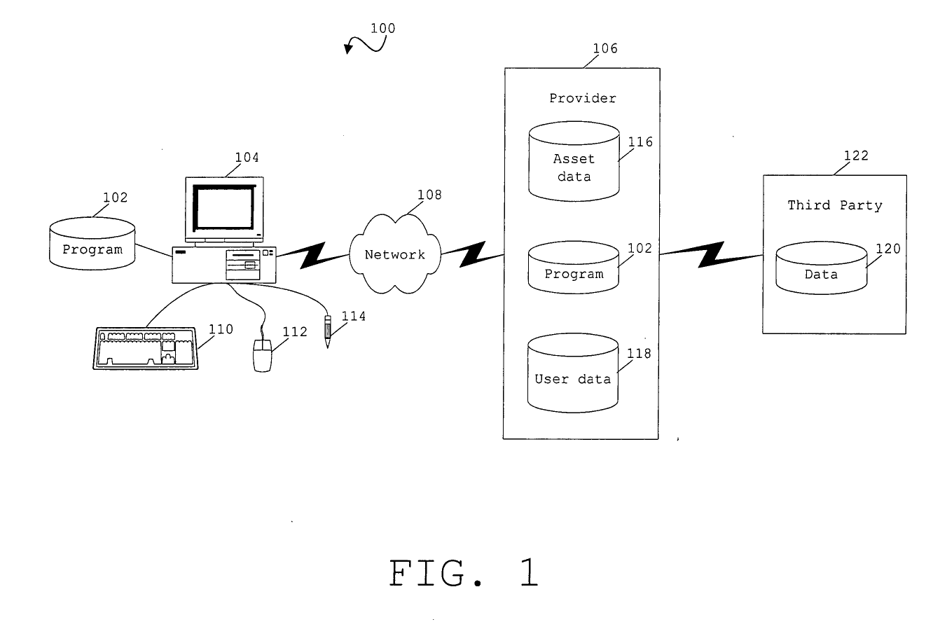

Referring to FIG. 1, an example network configuration 100 includes a risk management program 102, which is an interactive risk analysis tool that helps a user at a user terminal 104 organize, analyze, adjust, and otherwise manage an investment portfolio or portfolios based on an investor's risk and tax priorities. In this example, the user is an investor managing his or her own investment portfolio. Alternatively, the user can be a decision-maker managing an investment portfolio belonging to another party. The user terminal 104 downloads the program 102 from a provider 106 through a network 108 or otherwise obtains access to the program 102 (e.g., as a standalone software package, through a web site associated with the provider 106, etc.).

The program 102 provides information on a sub-portfolio to the user such as the sub-portfolio's risk. Risk generally refers to the volatility of an investment's historical returns. Volatility generally refers to the characteristic of a security to rise or fall sharply in price in a short amount of time. A measure of the relative volatility of a security in relation to the overall market is called a beta. The beta is the covariance of a security in relation to a market benchmark. For example, if a market index (e.g., S&P 500 stock index) has a beta coefficient of one, a stock with a higher beta is more volatile than the market index, and a stock with a lower beta can be expected to rise and fall more slowly than the market index. A conservative investor whose main concern is preservation of capital may focus on stocks with low betas, whereas one willing to take high risks in an effort to earn high rewards may look for high-beta stocks.

The program 102 includes features that enable the user to evaluate his or her investment portfolio from a risk perspective and to target risk or return characteristics of a particular broad market index, sector index, and/or investment strategy. An independent factor model, based on financial data from various asset classes, enables efficient risk analysis for any portion of the user's investment portfolio. The user can access summarized risk and tax information regarding his or her investment portfolio and perform additional analysis on the investment portfolio. The user can input different investment strategies and choices and select different types of portfolio analyses for the program 102 to perform. The results of the different analyses are displayed on the user terminal 104 as textual and/or graphical reports. The user can manipulate the results using a keyboard 110, a mouse 112, a touch screen on the user terminal 104, a stylus 114, or other similar mechanism.

From the results, the user can view or change various investment portfolio options based on user-input information such as tax and investment preferences. The user can view the options on a graphical depiction of investment strategies, including graphs and/or tables that show information, such as projected asset levels and investment diversification, that efficiently display relevant investment portfolio information to the user and help the user evaluate his or her investment options and the risk associated with the investment portfolio and help the user attempt to manage that risk considering options such as the user's investment objectives and risk comfort level.

The user can organize the investment portfolio into sub-portfolios according to various investment objectives or potential investment scenarios. Each sub-portfolio can contain assets from a variety of asset classes (e.g., stocks, mutual funds, bonds, municipals, cash). The assets in a portfolio or sub-portfolio are quantified by weights (e.g., number of shares or dollar amounts) of particular assets. The user can also keep the entire investment portfolio in a single sub-portfolio.

The user may compare volatility and the way that risk is spread in a sub-portfolio to the volatility and the way that risk is spread in various risk target portfolios, including asset allocation risk targets, broad market risk targets, and specialized risk targets. Such a comparison may help the user determine which investment choices can better align risk in the user's sub-portfolio to the risk level of chosen risk targets.

Reporting tools (e.g., asset data 116 and user data 118) are available to the program 102 to provide information for portfolio analysis performed by the program 102 and for any textual and/or graphical reports of such analysis. The program 102 accesses the asset data 116 and the user data 118 from the provider 106 through the network 108. As described further below, the asset data 116 includes periodically-updated (e.g., hourly, daily, twice daily, weekly, monthly, etc.) historical information about various assets and asset classes for the past X years, Y months, Z days, or other time frame.

The updated historical information may come from the provider's resources and/or from data 120 provided by a third party 122. For example, the third party 122 may provide asset returns for assets included in an investment portfolio, while the provider 106 may generate composite returns for asset classes that cannot be obtained from the third party 122 such as for assets in a country that does not have any exchanges or reliable information. The third party 122 is shown as one entity for simplicity; the provider 106 may obtain data from any number of third parties.

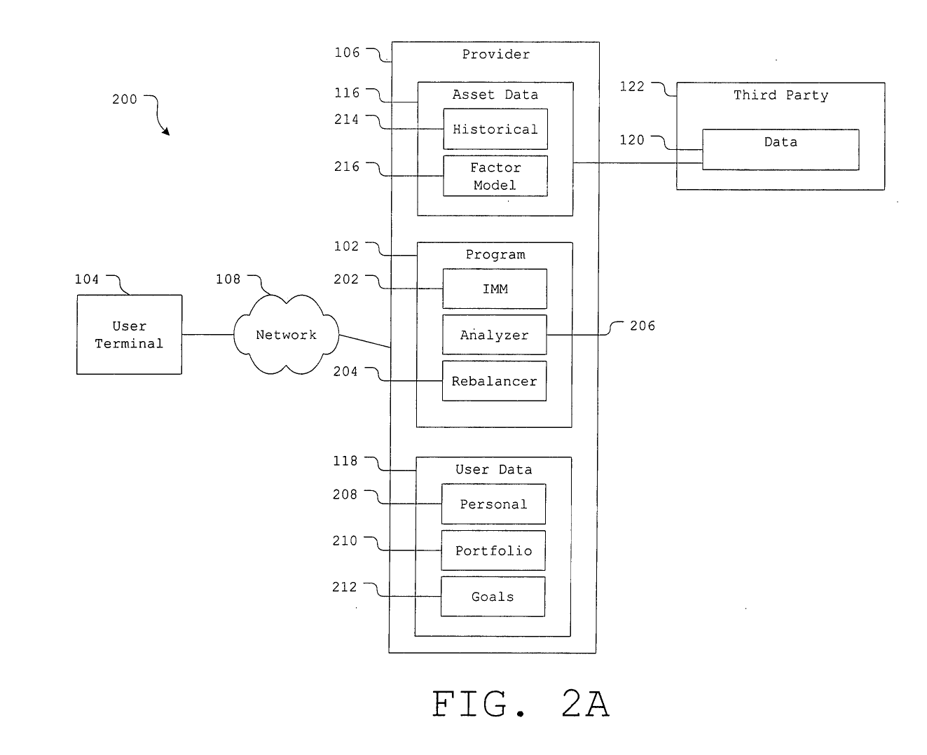

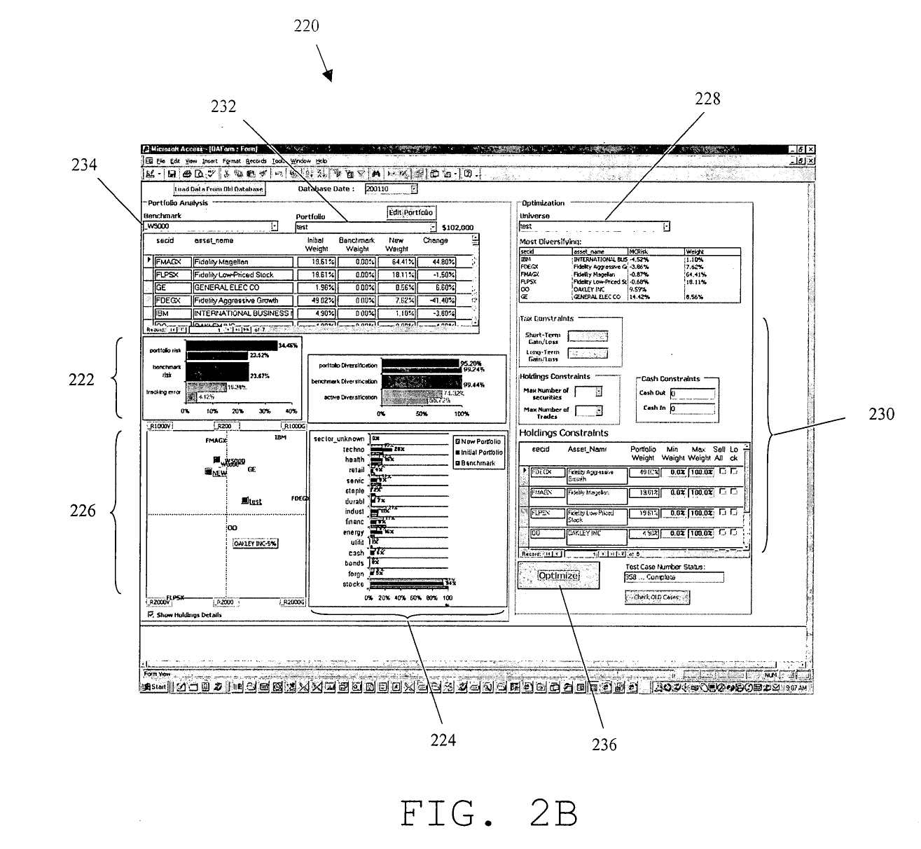

Referring to FIG. 2A, a network setup 200 illustrates an example alternate view of the network configuration 100 of FIG. 1. Although the network setup 200 is described with reference to the elements included in FIG. 1, the network setup 200 may be implemented in this or a similar manner with these or with similar elements (including a setup with more or fewer elements).

From the user terminal 104, the user can access the provider 106 (more specifically, the program 102) and analyze his or her investment portfolio. As described further below, the program 102 helps the user:
a) accumulate current investment portfolio and user information (using an identifier, mapper, and merger (IMM) 202 included in the program 102),
b) organize the user's assets into sub-portfolios based on the user's investment objectives,
c) choose a risk target, investment options, and constraints to help achieve objectives for each sub-portfolio,
d) rebalance sub-portfolio assets to better correlate with risk characteristics of the chosen risk target (using a rebalancer 204 included in the program 102),
e) analyze the rebalanced, hypothetical sub-portfolio and compare the results against the chosen risk target, other scenarios, or existing sub-portfolios (using an analyzer 206 included in the program 102), and
f) perform other similar tasks.

In accumulating current investment portfolio and user information, the program 102 gathers user information from the user data 118 at or accessible by the provider 106 and/or from the user via user inputs to the user terminal 104 transmitted over the network 108 to the provider 106 and typically stored in the user data 118. The user data 118 in this example includes personal data 208 (e.g., name, income and tax information, etc.), portfolio information 210 (e.g., assets held inside and outside the provider 106), and goal information 212 (e.g., goal types such as retirement and education funding, asset contributions to goals, etc.). The user data 118 can include data on any number of users, for example, with the data organized as a database.

The program 102 gathers characteristics about assets included in the user's current portfolio (e.g., the user's actual, real time portfolio) as determined by the supplied portfolio information 210. The asset characteristics come from a collection of asset data 116 included at or otherwise accessible by the provider 106. The asset data 116 includes asset information such as historical data 214 (e.g., past return values for assets and indices from various asset classes) and factor model data 216 (i.e., parameters associated with the factor model used to calculate risk). The asset data 116 may be determined or calculated based on data 120 provided by a third party 122.

Having accumulated information on the user and the user's investment portfolio, the program 102 helps the user organize his or her assets. In enabling such organization, the program 102 helps the user choose combinations of accounts and positions (including individual tax lots) to construct sub-portfolios that organize the user's entire investment portfolio (or the user's entire investment portfolio as known by the provider 106) to match the user's investment attitude. The user may organize the sub-portfolios manually, by goal, by investment strategy (e.g., small cap, technology, fun money, etc.), by asset class (e.g., all equity, all fixed income, all cash, etc.), by account or account registration type (e.g., existing accounts, tax-advantaged accounts, taxable accounts, 529 plans, trusts, etc.), as one total portfolio, or in another way.

Once the user organizes his or her portfolio into sub-portfolios, the program 102, using the analyzer 206, analyzes each of the sub-portfolios. On the user terminal 104, the user can view textual and graphical information related to a sub-portfolio and interact with the program using a graphical user interface. FIG. 2B shows an example of a screen shot 220 showing a portion of the graphical user interface. To help the user compare a sub-portfolio to a risk target, the program 102 transmits information generated by the analyzer 206 to the user terminal 104. The user can then view graphical information such as charts of risk performance 222 of the sub-portfolio compared with risk performance of a risk target, a sector bar chart 224 showing the percentage of the sub-portfolio in each of various equity sectors compared with the risk target's equity sector breakdown, an investment style map 226 of the sub-portfolio and the risk target, and other similar types of information. The graphical information helps the user select which risk target meets the user's specific risk control priorities and/or investment objectives for a particular sub-portfolio. The program 102 uses the selected risk target in rebalancing the sub-portfolio with the rebalancer 204.

The program 102 also helps the user select investments that he or she is comfortable owning, the user's so-called investment universe. The rebalancer 204 uses this investment universe in rebalancing the user's sub-portfolio. To help the user select investments for his or her investment universe, the program 102 provides a list or summary of possible investments and/or investment characteristics (e.g., ratings, prices, etc.) to the user. Such possible investments may be gathered from the asset data 116 (including data acquired from the third party 122). The program 102 can save several versions of a user's investment universe and allow the user to select a version 228 to use in an analysis.

The program 102 may also enable the user to choose constraints 230 to constrain the rebalancer 204. As illustrated, constraints 230 enable the user to realize gains and losses upon rebalancing, limit the number of trades needed to accomplish rebalancing, limit the total number of assets held in an account after rebalancing, instruct the rebalancer 204 to take cash in or out of an account, and/or instruct the rebalancer 204 to sell or not sell part or all of a position (down to the lot level).

A user can select any number of the sub-portfolios in the investment portfolio to rebalance. To rebalance a sub-portfolio (e.g., selected using 232), the user chooses a risk target (e.g., using 234), selects an investment universe (e.g., using 228), and designates any constraints for the sub-portfolio (e.g., using 230). After making the desired selections, the user selects (e.g., using button 236) to rebalance the sub-portfolio to more closely correlate the risk in the sub-portfolio with the risk in the corresponding risk target. The program 102, via the rebalancer 204, performs the rebalancing.

Generally, the rebalancer 204 selects investments from the sub-portfolio's investment universe whose overall risk characteristics, when viewed together with assets remaining in the sub-portfolio, are similar to those of the selected risk target. After rebalancing, the program 102 presents to the user a hypothetical rebalanced sub-portfolio on the user terminal 104. The user may also see a list of the assets that the user would need to buy, sell, and/or hold to make the user's actual investment portfolio include the rebalanced sub-portfolio. The program 102 allows the user to confirm and enable any activity that can change accounts and assets associated with the user's actual investment portfolio.

The user can analyze the relative risk, performance, and tax implications of the rebalanced sub-portfolio, existing accounts, and the chosen risk target. The analyzer 206 performs such analysis. In analyzing the relative risk, the analyzer 206 estimates the risk of the rebalanced sub-portfolio against the user's existing sub-portfolio, risk target, and market benchmarks in terms of volatility and the allocation of assets among different kinds of assets with different risk and return characteristics. The analyzer 206 gauges these results in terms of concerns such as risk, return, asset allocation, investment sector exposure, historical returns, and estimated tax consequences.

In analyzing performance, the analyzer 206 can perform various types of analysis. For example, the analyzer 206 can examine historical returns of an existing or rebalanced sub-portfolio. The analyzer 206 can also compare the sub-portfolio returns to the returns of the user's chosen risk target. In analyzing tax implications, the analyzer 206 can estimate the capital gains/losses in the user's existing sub-portfolio as well as in the rebalanced sub-portfolio.

After the user receives results of the analysis, typically on a graphical user interface (e.g., 220) at the user terminal 104, the user can make different choices (e.g., choose a different risk target, change the investment universe, etc.), rebalance the new sub-portfolio assets, analyze the new rebalanced portfolio, and view the new results. The user may repeatedly make different choices, rebalance, and analyze the results.

The program 102 may save previous choices and any correlating results (e.g., rebalancing and analysis results) for later reference by the user. Such saved information may be kept indefinitely, for a specified time period (e.g., one hour, twenty-four hours, one week, etc.), for the current risk management session (e.g., during the instant network connection between the user terminal 104 and the provider 106), or for another interval.

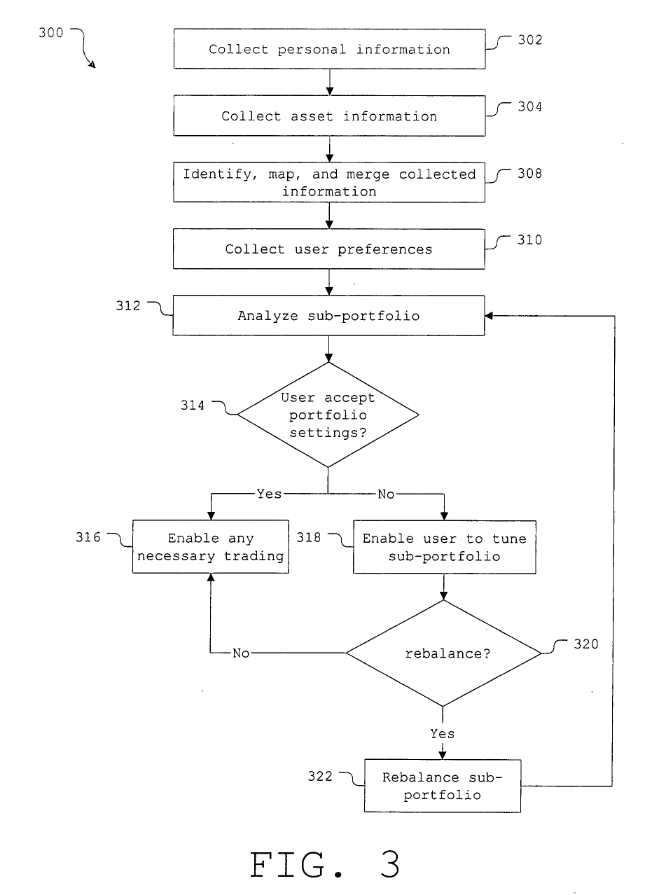

FIG. 3 illustrates an example risk management process 300 performed by the program 102 when analyzing a user's investment portfolio. Although the process 300 is described with reference to the elements included in FIGS. 1 and 2, the process 300 may be implemented in this or a similar manner with these or similar elements (including a setup with more or fewer elements).

In the process 300, through the user terminal 104, the user can access the provider 106 over the network 108. Typically, the user accesses a website associated with the provider 106 and accesses the program 102 by clicking on a link for a risk management program. The user may need to log in with the provider 106 to access the program 102 and/or information related to the user.

Once the user accesses the program 102, the program 102 collects 302 personal information from the user. The user typically enters any requested information via a browser at the user terminal 104 and transmits the personal information to the provider 102 over the network 108, possibly using a connection secured with encryption or other security mechanism.

The provider 106 may already have any necessary information on the user in the user data 118 and may not need to collect 302 any personal information from the user at this time. However, the program 102 may still prompt 302 the user to update personal information or to affirm that no information had changed since the user's last program session, since the last time the user updated his or her personal information, or since another specified time.

If the program 102 does collect 302 personal information, then the program 102 may also collect personal and/or investment information specific to the user. Examples of personal information 208 include identifiers (e.g., name, user identification code/name, address, electronic mail address, etc.), household income, income tax information, income in retirement, and other similar types of information. Examples of investment information include portfolio information 210 (e.g., accounts held inside and outside the provider 106, tax-lot information, cost basis information, etc.), goal information 212 (e.g., goal type, goal years, contributions to goals from various investments, etc.), and other similar types of information.

The program 102 also gathers information related to the user's assets, typically by gathering information from the asset data 116, or from a third party 122. For example, the program 102 may collect 304 asset information from the historical data 214, such as one year's worth of returns for each stock in the user's investment portfolio.

Having collected user, asset, and any other similar type of information, the program 102 identifies, maps, and merges 308 the information using the IMM 202. The IMM 202 identifies the specific assets in a user's investment portfolio and obtains financial information, such as past return values, for each asset. For example, if any of the assets in a user's investment portfolio are unknown or have unknown return histories, the IMM 202 maps each unknown asset to a proxy asset (e.g., an index) from a similar asset class. The IMM 202 also merges financial data from various asset classes to determine values for a set of risk factor coefficients for each asset. The risk factor coefficients represent risk associated with that asset according to a risk model with K independent risk factors determined by the program 102, explained in more detail below.

The program 102 transmits information about the user's investment portfolio, including information about the user's accounts as processed by the IMM 202, to the user terminal 104. The user can use the information transmitted by the program 102 to create sub-portfolios and set other user preferences. The user preferences include preferences relating to potential trading to rebalance any of the sub-portfolios. For example, as described above, the user can select a risk target for each sub-portfolio, an investment universe for each sub-portfolio, and any constraints (e.g., to limit tax gains/losses or trade commissions paid) to help meet the users investment goals. Once the user enters his or her preferences, the program 102 collects 310 the user preferences.

The program 102 then analyzes 312 the investment portfolio comparing each sub-portfolio with the selected risk target for that sub-portfolio. The program 102 uses the analyzer 206 to perform risk calculations and present the results to the user. For example, the analyzer 206 can calculate “portfolio risk” and “active risk” for any or all of the sub-portfolios.

Portfolio risk is an estimate of a range over which the return of the portfolio is likely to fluctuate, and can be quantified by the following function that takes into account the weighted contribution of each risk factor to the risk of the portfolio: where wᵢ represents the weight of asset i in the portfolio, wⱼ represents the weight of asset j in the portfolio, βᵢₖ is a risk factor coefficient representing the sensitivity of asset i to risk

$$Portfolio Risk = \sqrt{{\sum }_{i} {\sum }_{j} {\sum }_{k} {w}_{i} {w}_{j} {β}_{ik} {β}_{jk} {σ}_{k}^{2} + {\sum }_{i} {w}_{i}^{2} {s}_{i}^{2}}$$

factor k, βⱼₖ is a risk factor coefficient representing the sensitivity of asset j to risk factor k, σₖ² represents the variance of risk factor k, and sᵢ² represents the specific risk of asset i. This equation for portfolio risk can also be used to calculate the risk of a single asset where there is only one nonzero wᵢ value.

Active risk is an estimate of a tracking error between a portfolio and a risk target, capturing the extent to which the return of the portfolio is likely to vary more or less in sync with the return of the risk target:

$$Active Risk = \sqrt{{\sum }_{i} {\sum }_{j} {\sum }_{k} {w}_{i} {w}_{j} ( {β}_{ik} - {β}_{k}^{′} ) ( {β}_{jk} - {β}_{k}^{′} ) {σ}_{k}^{2} + {\sum }_{i} {( {w}_{i} - {w}_{i}^{′} )}^{2} {s}_{i}^{2}}$$

where βₖ′ is a risk factor coefficient representing the sensitivity of the risk target to risk factor k, wᵢ′ represents the weight of asset i in the risk target, and other symbols are interpreted as described above.

After the program 102 transmits information generated by the analyzer 206 to the user terminal 104, the user can decide whether to accept 314 the current sub-portfolio settings. If the user does accept the current sub-portfolio settings the program 102 enables 316 any necessary trading based on changes the user desires to make in assets of any of the sub-portfolios. If the user does not accept the current sub-portfolio settings the program 102 enables 318 the user to tune the sub-portfolios (e.g., manually select new sub-portfolio assets, change risk targets, goals, constraints, etc.). The user can then decide 320 whether to have the program 102 rebalance 322 any of the sub-portfolios.

The program 102 uses the selected risk target to rebalance a sub-portfolio with the rebalancer 204. In the rebalancing process, the rebalancer 204 selects weights of assets held in a sub-portfolio to change its risk profile, as characterized by the set of K risk factors, and determines an investment strategy to best satisfy the user. The rebalancer 204 chooses weights of assets in a sub-portfolio's investment universe, where the weight is zero if the asset is not in the sub-portfolio. Using the risk factors, the rebalancer 204 can investigate possible trade-offs in terms of diversification with respect to the risk profile of the risk target. Since the risk factors are independent (i.e., correspond to statistically independent random variables), the rebalancer 204 can perform efficient risk calculations based on financial data from multiple asset classes. For example, the rebalancer 204 can minimize the active risk to match the risk of a portfolio to that of a risk target.

The rebalancer 204 can take any tax consequences of exchanging assets into account in determining a target portfolio strategy. The rebalancer 204 uses tax data such as tax-lot information and standard tax accounting rules to constrain the rebalancing and therefore help the user leverage the tax information. For instance, the user can indicate a tax-related gain or loss that the rebalancer 204 may use in its rebalancing process. The user retains the decision whether to keep or sell individual lots.

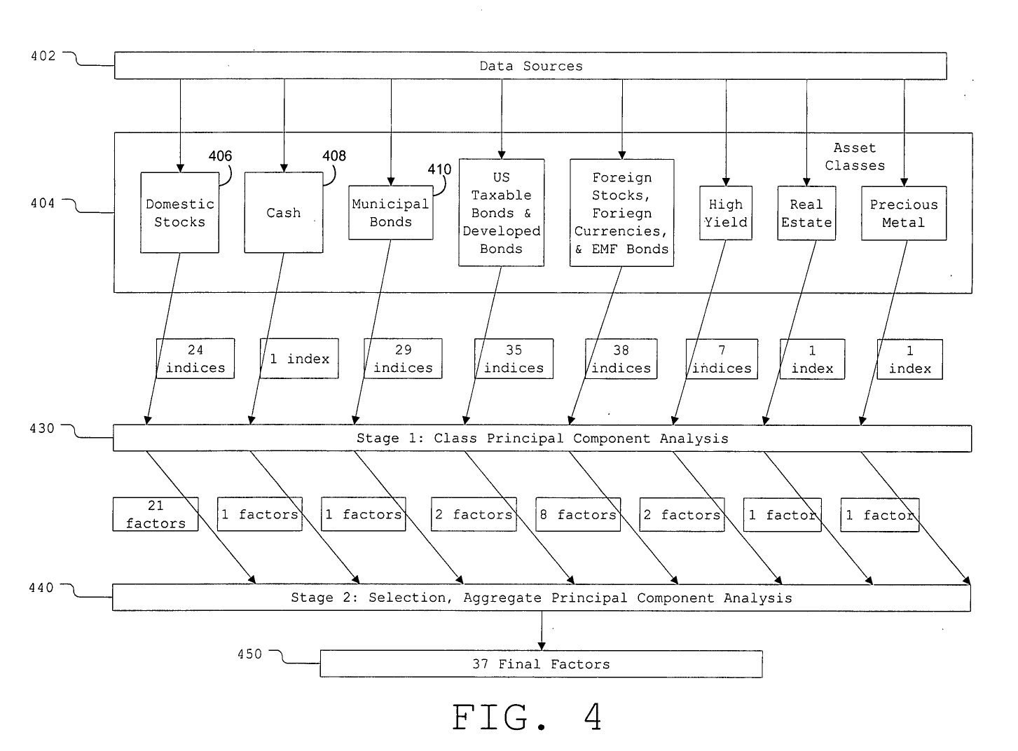

FIG. 4 is a diagram illustrating an example of a procedure for determining the K independent risk factors upon which the portfolio risk and active risk calculations are based. In particular, the program 102 determines the risk factor coefficients for each asset included in a risk calculation. In this example K=37. The program 102 gathers sets of financial data from data sources 402 associated with a variety of asset classes 404. In the illustrated example, each set of financial data associated with an asset class is one or more index return series, where each index return series is a collection of historical prices (i.e., return values) for a financial index (e.g., Russell Growth & Value Index) representing that asset class. The domestic stocks class 406 has an index return series xᵢ^{ds}[t] where i=1, . . . , 24 represents one of 24 indices chosen to represent the domestic stocks class 406, and t=1, . . . , T represents one of T historical dates in the return series (e.g., T days of return values). Some of the asset classes 404 are represented by a single index, such as the cash class 408 which has a single index return series x^{c}[t] (e.g., representing the change in the value of the U.S. dollar), where t=1, . . . , T represents the same set of T historical dates used for the other asset classes.

For the program 102 to perform efficient calculations (e.g., of portfolio risk), it is advantageous to obtain a concise description of typical variation of assets within an asset class. For asset classes represented by more than one index, such as domestic stocks 406, different index return series xᵢ^{ds}[t] corresponding to different values of i may be correlated with one another. Such correlations can be removed to provide more concise variation information, for example, return series that are uncorrelated with one another, enabling more efficient calculations. Such a set of mutually uncorrelated return series can be derived by performing a principal component analysis.

The program 102 performs two stages of principal component analysis. In a first stage 430, for each asset class having only a single index return series, the index return series is passed to the second stage 440 without a principal component analysis being performed for that asset class. For each asset class having more than one index return series, the program 102 performs the first stage 430 principal component analysis. The results of the first stage 430 principal component analysis for an asset class are a set of mutually uncorrelated return series, representing risk for that asset class. The program 102 then selects a subset of the mutually uncorrelated return series, for each asset class for which principal component analysis was performed. A goal of this selection process is to capture most of the variation in each asset class with a small number of risk factors associated with all of the asset classes 404. In the example of FIG. 4, the program 102 selects 21 out of 24 factors to represent the domestic stocks class 406, as explained in more detail below. Since the cash class 408 only has a single index return series, no principal component analysis or selection is necessary for that class. Selection for the other asset classes in 404 proceeds as indicated in FIG. 4.

In the second stage 440, the program 102 performs an aggregate principal component analysis with an aggregate set of return series representing variation within all of the asset classes 404. This results in a final set of mutually independent risk factors 450, 37 final factors in this example, represented by a set of mutually uncorrelated return series that can be used to determine risk factor coefficients (a measure of sensitivity to risk factors similar to a beta described above) for any asset for which historical data is available.

As described above, the program 102 selects a subset of the mutually uncorrelated return series for each asset class with multiple indices. To accomplish this, the program 102 first performs principal component analysis in the first stage 430, for example, for an asset class having S index return series xᵢ[t], for i=1, . . . , S. The principal component analysis yields a set of S eigenvectors vᵢ(j), and corresponding eigenvalues e(j), for j=1, . . . , S, of an estimated covariance matrix

$${K}_{mn} = \frac{1}{T} {\sum }_{t = 1}^{T} ( {x}_{m} [ t ] - {\overline{x}}_{m} ) ( {x}_{n} [ t ] - {\overline{x}}_{n} )$$

where \overline{x}ᵢ is the mean of xᵢ[t] over t. Each eigenvector corresponds to an independent risk factor that is associated with the asset class. Eigenvectors having larger eigenvalues represent more of the variation in the asset class. Using the eigenvectors, the program 102 calculates a set of mutually uncorrelated return series, and selects a subset to represent independent risk factors for the asset class.

The selection of the subset of mutually uncorrelated return series is based on the ability of the resulting final independent risk factors to successfully model risk of assets. The process of selecting a subset of the mutually uncorrelated return series can be iterated (e.g., by trial and error) based on criteria for one or more assets. For example, selecting the half of the return series representing most of the risk in an asset class results in a selected subset of mutually uncorrelated return series

$${x}_{j}^{′} [ t ] = {\sum }_{i = 1}^{S} {x}_{i} [ t ] {v}_{i} ( j ) , for j = 1 , … , S / 2 ,$$

where the eigenvectors vᵢ(j) are sorted by the size of their eigenvalues e(j) from largest to smallest. The number of mutually uncorrelated return series selected for any of the asset classes can be increased or decreased to attempt to achieve goals including obtaining a small number of final risk factors and obtaining accurate risk factor coefficients for one or more assets based on a figure of merit (e.g., the mean of the error term eᵢ[t] of the regression to determine the risk factor coefficients for an asset, as explained below).

All of the selected mutually uncorrelated return series x′ⱼ[t], from all of the asset classes, collectively form an aggregate set of return series. Since any two of the selected mutually uncorrelated return series from different asset classes are not necessarily uncorrelated with each other, the aggregate set of return series is not necessarily mutually uncorrelated. Therefore, in the second stage 440, the program 102 performs a final principal component analysis on this aggregate set of return series to yield a final set of mutually uncorrelated return series yₖ[t] for k=1, . . . , 37, representing 37 final independent risk factors that can be used to efficiently estimate risk for an asset associated with any one or combination of asset classes 404.

In an example of a process used by the IMM 202 to determine the set of risk factor coefficients βᵢₖ for an asset i, the IMM 202 performs a regression to fit a line in the space of risk factors (as represented by the final set of mutually uncorrelated return series yₖ[t]) to historical return values rᵢ[t] for the asset i according to

$${r}_{i} [ t ] = {α}_{i} + {\sum }_{k = 1}^{37} {β}_{ik} {y}_{k} [ t ] + {e}_{i} [ t ] .$$

The IMM 202 chooses the risk factor coefficients βᵢₖ to minimize the mean (over t) of the square of the error eᵢ[t]. The IMM 202 also determines other values used in the risk calculations, such as the factor variance σₖ² which can be estimated by σₖ²=var(yₖ[t]), and the specific risk sᵢ² which can be estimated by sᵢ²=var(eᵢ[t]).

A number of embodiments of the invention have been described. Nevertheless, it will be understood that various modifications may be made without departing from the spirit and scope of the invention. Some alternatives follow that illustrate, but in no way limit, some possible alternative implementations of various aspects of the examples described above.

The user terminal 104 can include any mechanism or device capable of communicating with the provider 106 through the network 108. Examples of the user terminal 104 include workstations, stationary personal computers, mobile personal computers, servers, personal digital assistants, pagers, telephones, and other similar mechanisms and devices. Although one user terminal is shown in the network configuration 100, multiple user terminals can access the provider 106 through the network 108.

The provider 106 may be set up as any device capable of communicating with the network 108 and accessing any necessary collections of data such as a file server, an application server, a database server, a mobile computer, a stationary computer, or other similar device.

The network configuration 100 can include any kind and any combination of networks such as an Internet, a local area network (LAN), a wide area network (WAN), a private network, a public network, or other similar network. Communications through the network configuration 100 may be secured with a mechanism such as IP security (IPsec), Transport Layer Security/Secure Socket Layer (TLS/SSL), wireless TLS (WTLS), secure Hypertext Transfer Protocol (S-HTTP), or other similar security mechanism.

Information transmitted between elements may be transmitted as blocks of data generally referred to as packets. The unit of packet data could include an entire network packet (e.g., an Ethernet packet) or a portion of such a packet. The packets may have a variable or a fixed size. Packets with a fixed size are called cells. Each sent packet may be part of a packet stream, where each of the packets, called a segment, included in the packet stream fits together to form a contiguous stream of data. Information may be communicated between endpoints via multicast, unicast, or some combination of both.

Data can be communicated between elements on communication links. The communication links can include any kind and any combination of communication links such as buses, physical ports, modem links, Ethernet links, cables, point-to-point links, infrared connections, fiber optic links, wireless links, cellular links, Bluetooth, satellite links, and other similar links. Additionally, each of the communication links may include one or more individual communication links.

Furthermore, the network configuration 100 is simplified for ease of explanation. The network configuration 100 may include more or fewer additional elements such as networks, communication links, proxy servers, hubs, bridges, switches, routers, processors, storage locations, firewalls or other security mechanisms, Internet Service Providers (ISPs), and other elements.

The techniques described here are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program may be implemented in a high level procedural or object oriented programming language to communicate with a machine system. However, the programs can be implemented in assembly or machine language, if desired. In any case, the language may be a compiled or interpreted language.

Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be considered to be implemented as a machine-readable storage medium, configured with a program, where the storage medium so configured causes a machine to operate in a specific and predefined manner.

Other embodiments are within the scope of the following claims.

1. A method comprising:
receiving asset classes with corresponding sets of financial data;
determining variation information for the sets of financial data; and
determining a final set of factors based on the variation information.

2. The method of claim 1 further comprising determining risk associated with a portfolio of one or more assets using information derived from the final set of factors.

3. The method of claim 2 wherein the information derived from the final set of factors comprises risk factor coefficients calculated using a regression based on the final set of factors and historical data for the one or more assets.

4. The method of claim 1 wherein determining the final set of factors comprises:
determining an initial set of factors based on the variation information; and
determining the final set of factors based on a plurality of principal components associated with the initial set of factors.

5. The method of claim 1 wherein the final set of factors are associated with mutually independent random variables.

6. The method of claim 5 wherein the final set of factors correspond to mutually uncorrelated series of numbers, respectively corresponding to series of samples of the mutually independent random variables.

7. The method of claim 1 wherein a first one of the sets of financial data comprises a plurality of index return series, each index return series comprising a plurality of historical prices of a financial index.

8. The method of claim 7 wherein the variation information for the first one of the sets of financial data comprises a set of mutually uncorrelated return series.

9. The method of claim 8 wherein determining the variation information for the first one of the sets of financial data comprises:
calculating a first covariance matrix based on the plurality of index return series;
calculating a first set of eigenvectors and corresponding first set of eigenvalues for the first covariance matrix;
selecting a subset of the first set of eigenvectors, based on the corresponding first set of eigenvalues; and
determining the set of mutually uncorrelated return series based on the subset of the set of eigenvectors.

10. The method of claim 9 wherein determining the final set of factors comprises:
calculating a second covariance matrix based on an aggregate set of return series which includes the set of mutually uncorrelated return series;
calculating a second set of eigenvectors for the second covariance matrix; and
determining the final set of factors based on the second set of eigenvectors.

11. An article of manufacture having computer-readable program portions embodied therein, the article comprising instruction for causing a processor to:
receive asset classes with corresponding sets of financial data;
determine variation information for the sets of financial data; and
determine a final set of factors based on the variation information.

12. A system for managing an investment portfolio comprising:
a factor module configured to
receive asset classes with corresponding sets of financial data;
determine variation information for each of the sets of financial data; and
determine a final set of factors based on the variation information.

13. The system of claim 12 further comprising an analyzer module configured to determine risk associated with a portfolio of one or more assets using information derived from the final set of factors.

14. The system of claim 13 further comprising a rebalancer module configured to determine a rebalanced portfolio based on risk associated with a risk target, wherein the risk associated with the rebalanced portfolio is closer to the risk associated with the risk target than the risk associated with the portfolio is close to the risk associated with the risk target.
